(19) United States
(12) Patent Application Publication
(10) Pub. No.: US 2022/0393232 A1
(43) Pub. Date: Dec. 8, 2022

(54) MEMBER FOR ELECTRICITY STORAGE DEVICES, AND ELECTRICITY STORAGE DEVICE

(71) Applicant: NIPPON ELECTRIC GLASS CO., LTD., Otsu-shi, Shiga (JP)

(72) Inventors: Hideo YAMAUCHI, Otsu-shi (JP); Kei TSUNODA, Otsu-shi (JP); Masaaki KADOMI, Otsu-shi (JP); Yoshinori YAMAZAKI, Otsu-shi (JP)

(21) Appl. No.: 17/775,405

(22) PCT Filed: Dec. 7, 2020
(86) PCT No.: PCT/JP2020/045399

§ 371 Date: May 9, 2022

(30) Foreign Application Priority Data
Dec. 19, 2019 (JP) 2019-229302

(51) Int. Cl. H01M 10/0562; H01M 10/0525; H01M 4/40

(52) U.S. Cl. CPC H01M 10/0562; H01M 10/0525; H01M 4/40; H01M 2004/027

(57) ABSTRACT

Provided is a member for an electricity storage device and an electricity storage device in each of which alkali metal ions are used as carrier ions and which can improve charge/discharge characteristics. A member for an electricity storage device includes: a solid electrolyte layer 2 containing an alkali metal ion-conducting solid electrolyte; an alkali metal layer 3 laid on the solid electrolyte layer 2 and containing an alkali metal; and an electrode layer laid on the alkali metal layer 3 and containing a material capable of absorbing and releasing alkali metal ions.

### TECHNICAL FIELD

The present invention relates to members for electricity storage devices and electricity storage devices in which the members for electricity storage devices are used.

### BACKGROUND ART

Lithium-ion secondary batteries have secured their place as high-capacity and light-weight power sources essential for mobile devices, electric vehicles, and so on. However, current lithium-ion secondary batteries employ as their electrolytes, mainly, combustible organic electrolytic solutions, which raises concerns about the risk of burning or the like. As a solution to this problem, developments of all-solid-state batteries using a solid electrolyte instead of an organic electrolytic solution have been promoted. Furthermore, because, as for lithium, there are concerns about such issues as global rise in raw material costs, studies have recently been conducted on sodium-ion all-solid-state secondary batteries as alternatives to lithium-ion all-solid-state secondary batteries.

Patent Literature 1 discloses an example of a sodium-ion all-solid-state battery in which a positive electrode, a solid electrolyte layer, and a negative electrode are layered one on top of another in this order. The solid electrolyte layer is made of a solid oxide electrolyte represented by Na_{1+y}Zr₂(SiO₄)_{y}(PO₄)_{3-y} (1≤y<3).

### CITATION LIST

### Patent Literature

### [PTL 1]

### JP-A-2010-015782

### SUMMARY OF INVENTION

### Technical Problem

All-solid-state batteries are less likely to form an ion-conducting path between the solid electrolyte layer and the electrode layer and are therefore often poor in charge/discharge characteristics.

An object of the present invention is to provide a member for an electricity storage device and an electricity storage device in each of which alkali metal ions are used as carrier ions and which can improve charge/discharge characteristics.

### Solution to Problem

A member for an electricity storage device according to the present invention includes: a solid electrolyte layer containing an alkali metal ion-conducting solid electrolyte; an alkali metal layer laid on the solid electrolyte layer and containing an alkali metal; and an electrode layer laid on the alkali metal layer and containing a material capable of absorbing and releasing alkali metal ions.

The electrode layer is preferably a negative electrode layer. In this case, a negative-electrode active material contained in the negative electrode layer is preferably a compound containing at least one selected from the group consisting of metal, alloy, graphite, and hard carbon and an alkali metal element of the same type as contained in the alkali metal layer.

At least a portion of the negative electrode layer is preferably made of an alloy containing the alkali metal element of the same type as contained in the alkali metal layer.

The alkali metal contained in the alkali metal layer is preferably diffused into the negative electrode layer.

The alkali metal element contained in the alkali metal layer is preferably Na and the negative-electrode active material is preferably a compound containing Na.

The negative-electrode active material preferably contains at least one element selected from the group consisting of Sn, Bi, Sb, and Pb.

The member for an electricity storage device according to the present invention is suitable when the electrode layer contains a binder.

The member for an electricity storage device according to the present invention is suitable when the solid electrolyte layer contains an oxide.

The alkali metal layer preferably has a thickness of not less than 5 nm and not more than 500 μm.

An electricity storage device according to the present invention includes the above-described member for an electricity storage device, wherein the electrode layer of the member for an electricity storage device is a first electrode layer. and the electricity storage device further includes a second electrode layer laid on the solid electrolyte layer so as to sandwich the solid electrolyte layer together with the alkali metal layer.

### Advantageous Effects of Invention

The present invention enables provision of a member for an electricity storage device and an electricity storage device in each of which alkali metal ions are used as carrier ions and which can improve charge/discharge characteristics.

### BRIEF DESCRIPTION OF DRAWINGS

FIG. 1 is a frontal cross-sectional view of a member for an electricity storage device according to a first embodiment of the present invention.

FIG. 2 is a frontal cross-sectional view of a member for an electricity storage device according to a modification of the first embodiment of the present invention.

FIG. 3 is a frontal cross-sectional view of an electricity storage device according to a second embodiment of the present invention.

FIGS. 4(a) and 4(b) are frontal cross-sectional views for illustrating an example of a method for producing the electricity storage device according to the second embodiment of the present invention.

FIGS. 5(a) and 5(b) are frontal cross-sectional views for illustrating the example of the method for producing the electricity storage device according to the second embodiment of the present invention.

FIGS. 6(a) and 6(b) are frontal cross-sectional views for illustrating another example of a method for producing the electricity storage device according to the second embodiment of the present invention.

FIGS. 7(a) and 7(b) are frontal cross-sectional views for illustrating still another example of a method for producing the electricity storage device according to the second embodiment of the present invention.

FIGS. 8(a) and 8(b) are frontal cross-sectional views for illustrating an example of a method for producing an electricity storage device using the member for an electricity storage device according to the modification of the first embodiment of the present invention.

### DESCRIPTION OF EMBODIMENTS

Hereinafter, a description will be given of preferred embodiments. However, the following embodiments are merely illustrative and the present invention is not intended to be limited to the following embodiments. Throughout the drawings, members having substantially the same functions may be referred to by the same reference characters.

[Member for Electricity Storage Device]

### First Embodiment

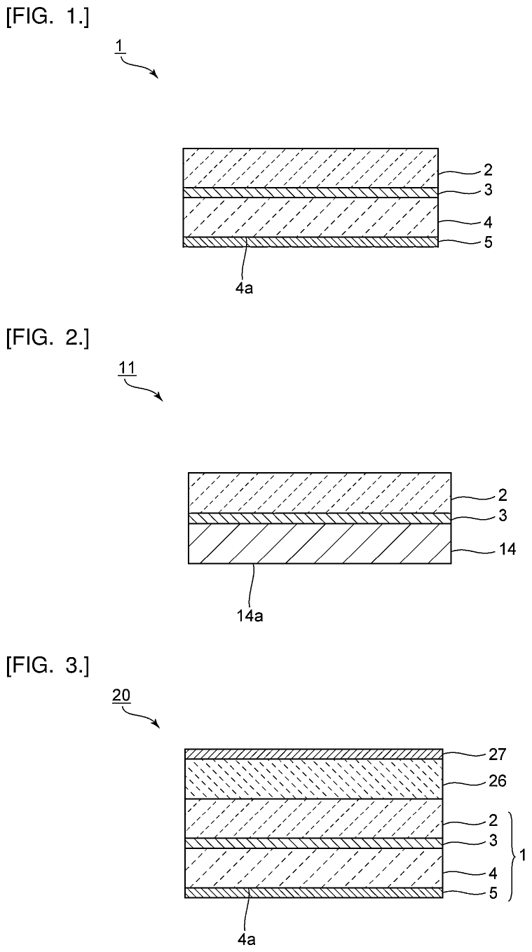

FIG. 1 is a frontal cross-sectional view of a member for an electricity storage device according to a first embodiment of the present invention. As shown in FIG. 1, a member 1 for an electricity storage device includes a solid electrolyte layer 2, an alkali metal layer 3, and a negative electrode layer 4. Specifically, the alkali metal layer 3 is laid on the solid electrolyte layer 2. The negative electrode layer 4 is laid on the alkali metal layer 3.

The solid electrolyte layer 2 contains an alkali metal ion-conducting solid electrolyte. The negative electrode layer 4 is an electrode layer defined as the electrode layer containing a material capable of absorbing and releasing alkali metal ions in the present invention. However, the electrode layer containing a material capable of absorbing and releasing alkali metal ions is not necessarily the negative electrode layer, but may be a positive electrode layer.

An appropriate alkali metal, such as Li, Na or K, can be used for the alkali metal layer 3. The thickness of the alkali metal layer 3 is preferably not less than 5 nm, more preferably not less than 50 nm, and still more preferably not less than 500 nm. Thus, the solid electrolyte layer 2 and the negative electrode layer 4 can be suitably bonded together by the alkali metal layer 3. The upper limit of the thickness of the alkali metal layer 3 is not particularly limited, but it is preferably, for example, not more than 500 μm. If the alkali metal layer 3 is too thick, the safety may be impaired. In this embodiment, the negative electrode layer 4 is thicker than the alkali metal layer 3. In this case, the safety can be suitably enhanced.

The negative-electrode active material of the negative electrode layer 4 may be in the form of a metal foil or in a composite form. When the negative electrode layer 4 is in a composite form, the negative electrode layer 4 preferably contains a conductive agent and a binder. When the negative electrode layer 4 contains a binder, powder particles forming the negative-electrode active material can be suitably bound together. When the negative electrode layer 4 contains a conductive agent, a conducting path is formed, so that the internal resistance of the negative electrode layer 4 can be reduced.

At least a portion of the negative electrode layer 4 is made of a compound containing an alkali metal element of the same type as contained in the alkali metal layer 3. Specifically, the alkali metal contained in the alkali metal layer 3 is diffused into the negative electrode layer 4. Thus, at least a portion of the negative electrode layer 4 around the surface thereof in contact with the alkali metal layer 3 is made of a compound containing the alkali metal element. When the negative-electrode active material of the negative electrode layer 4 is in the form of a metal foil, the compound containing the alkali metal element is an alloy containing the alkali metal element. Also when the negative-electrode active material of the negative electrode layer 4 is in a composite form, the compound containing the alkali metal element may be an alloy containing the alkali metal element.

The negative electrode layer 4 has an outer principal surface 4a. The outer principal surface 4a is a principal surface located nearer the outside of the member 1 for an electricity storage device. In this embodiment, the component percentage of the alkali metal element in the negative electrode layer 4 decreases toward the outer principal surface 4a. As just described, the negative electrode layer 4 has a gradient of the component percentage of the alkali metal element. However, the component percentage of the alkali metal element may be uniform throughout the negative electrode layer 4. The negative electrode layer 4 may not necessarily contain the alkali metal element.

A feature of this embodiment is that, in the member 1 for an electricity storage device, the alkali metal layer 3 is laid between the solid electrolyte layer 2 and the negative electrode layer 4. Since both the solid electrolyte layer 2 and the negative electrode layer 4 are in contact with the alkali metal layer 3, an ion-conducting path can be easily formed. In addition, because the alkali metal layer 3 has high flexibility, the surface shape of the alkali metal layer 3 can be easily conformed to both the surface shapes of the solid electrolyte layer 2 and the negative electrode layer 4. Thus, the adhesion between the alkali metal layer 3 and each of the solid electrolyte layer 2 and the negative electrode layer 4 can be effectively increased. Therefore, the ion-conducting path can be effectively enhanced. Hence, the charge/discharge characteristics of an electricity storage device in which the member 1 for an electricity storage device is used can be improved.

A current collector layer 5 is laid on the negative electrode layer 4. The current collector layer 5 may not necessarily be provided. However, the provision of the current collector layer 5 enables efficient current collection.

(Modification)

FIG. 2 is a frontal cross-sectional view of a member for an electricity storage device according to a modification of the first embodiment. In a member 11 for an electricity storage device, the negative-electrode active material of a negative electrode layer 14 is in the form of a metal foil. The negative electrode layer 14 contains an alloy of a metal capable of absorbing and releasing alkali metal ions and a metal neither absorbing nor releasing alkali metal ions. Thus, the volume change of the negative electrode layer 14 due to absorption and release of alkali ions during charge and discharge can be reduced, which increases the cycle characteristics. No current collector layer is formed on the negative electrode layer 14.

The electrical resistance of the metal neither absorbing nor releasing alkali metal ions for use in the negative electrode layer 14 is preferably lower than that of the metal capable of absorbing and releasing alkali metal ions for use in the negative electrode layer 14. In this case, efficient current collection can be achieved without provision of a current collector layer.

In this modification, at least a portion of the negative electrode layer 14 is made of a compound containing an alkali metal element of the same type as contained in the alkali metal layer 3. Specifically, at least a portion of the negative electrode layer 14 around the surface thereof in contact with the alkali metal layer 3 is made of an alloy containing the alkali metal element. The component percentage of the alkali metal element in the negative electrode layer 14 decreases toward the outer principal surface 14a.

The member for an electricity storage device according to the present invention can be used for an electricity storage device, such as, for example, an all-solid-state battery.

[Electricity Storage Device]

### Second Embodiment

FIG. 3 is a frontal cross-sectional view of an electricity storage device according to a second embodiment of the present invention. As shown in FIG. 3, an all-solid-state battery 20 serving as an electricity storage device includes a positive electrode layer 26 and a member 1 for an electricity storage device according to the first embodiment. The positive electrode layer 26 is laid on the solid electrolyte layer 2 of the member 1 for an electricity storage device. Specifically, the positive electrode layer 26 is laid on the solid electrolyte layer 2 so as to sandwich the solid electrolyte layer 2 together with the alkali metal layer 3. In this embodiment, the negative electrode layer 4 is the first electrode layer defined in the present invention and the positive electrode layer 26 is the second electrode layer defined in the present invention. A current collector layer 27 is laid on the positive electrode layer 26. However, the current collector layer 27 may not necessarily be provided.

A feature of this embodiment is that, in the member 1 for an electricity storage device, the alkali metal layer 3 is laid between the solid electrolyte layer 2 and the negative electrode layer 4. Since both the solid electrolyte layer 2 and the negative electrode layer 4 are in contact with the alkali metal layer 3, an ion-conducting path can be easily formed. In addition, because the alkali metal layer 3 has high flexibility, the surface shape of the alkali metal layer 3 can be easily conformed to both the surface shapes of the solid electrolyte layer 2 and the negative electrode layer 4. Thus, the adhesion between the alkali metal layer 3 and each of the solid electrolyte layer 2 and the negative electrode layer 4 can be effectively increased. Therefore, the ion-conducting path can be effectively enhanced. Hence, the charge/discharge characteristics of the electricity storage device can be improved.

When the negative electrode layer 4 contains an organic binder, P₂O₅, SiO₂ or the like, a depletion layer free of ions may be formed in the ion-conducting path and trap carrier ions. As a result, the discharge capacity and the cycle characteristics may decrease. To cope with this, in the member 1 for an electricity storage device, the alkali metal layer 3 can supply carrier ions. Thus, the charge/discharge efficiency and the cycle characteristics can be improved. As seen from this, the present invention is particularly suitable when the negative electrode layer 4 contains an organic binder or the like which is a material likely to form a depletion layer.

Furthermore, since the solid electrolyte layer 2 and the negative electrode layer 4 are bonded through the alkali metal layer 3, the negative electrode layer 4 is less likely to peel off. Thus, the cycle characteristics can be effectively improved. In addition, because the negative electrode layer 4 is less likely to peel off even when the amount of supported negative-electrode active material is increased, the capacity can be effectively increased.

When the negative-electrode active material of the negative electrode layer 4 contains an oxide, such as SnO, a conversion reaction occurs during a first charge. When the alkali metal is Li and the oxide is SnO, the reaction formula of the conversion reaction is represented by SnO+2Li⁺+2e⁻→Sn+Li₂O. Sn reduced from SnO by the conversion reaction is alloyed with Li as represented by Sn+4.4Li⁺+4.4e⁻→SnLi_{4.4}. This alloying is reversible and, during discharge, Li⁺ and electrons are released. On the other hand, the conversion reaction is basically irreversible. Therefore, during discharge, Li⁺ in Li₂O is not released and electrons used for reduction of SnO in the conversion reaction are also not released. Hence, electrons are consumed by the conversion reaction, which makes it likely that the first charge/discharge efficiency deteriorates.

To cope with the above problem, as in this embodiment, the negative electrode layer 4 is preferably a compound containing an alkali metal element of the same type as contained in the alkali metal layer 3. In this case, for example, when the negative-electrode active material contains Sn and the alkali metal element is Li, the negative electrode layer 4 contains an alloy of Sn and Li. Therefore, during a first discharge, Li⁺ and electrons in the alloy are released. Thus, even if a conversion reaction occurs during a first charge, the consumption of electrons can be compensated for. Hence, the charge/discharge efficiency can be improved. As seen from this, this embodiment is particularly suitable when the negative-electrode active material of the negative electrode layer 4 contains an oxide.

Hereinafter, a description will be given of the details of the negative electrode layer 4 as the electrode layer containing a material capable of absorbing and releasing alkali metal ions, the solid electrolyte layer 2, the positive electrode layer 26, the current collector layer 5, and the current collector layer 27, which are used in the all-solid-state battery 20.

Negative Electrode Layer (Electrode Layer Capable of Absorbing and Releasing Alkali Metal Ions);

When the negative-electrode active material of the negative electrode layer 4 is in the form of a metal foil, the negative-electrode active material contains a metal or an alloy. Specifically, the negative-electrode active material preferably contains at least one element selected from the group consisting of Al, Si, Ge, Sn, Bi, Sb, and Pb. When Li is used for the alkali metal layer 3, the negative-electrode active material particularly preferably contains at least one element selected from the group consisting of Al, Si, Ge, Sn, Sb, and Pb. On the other hand, when Na is used for the alkali metal layer 3, the negative-electrode active material particularly preferably contains at least one element selected from the group consisting of Sn, Bi, Sb, and Pb.

The negative electrode layer 4 may contain a metal element neither absorbing nor releasing alkali metal ions. Specifically, examples of the metal element neither absorbing nor releasing Li include Zn, Cu, Ni, Co, Mg, and Mo. Examples of the metal element neither absorbing nor releasing alkali metal ions include Zn, Cu, Ni, Co, Si, Al, Mg, Mo, and Fe.

When the negative-electrode active material of the negative electrode layer 4 is in the form of a metal foil, examples of the method for forming the negative electrode layer 4 include physical vapor deposition methods, such as evaporation coating and sputtering, and chemical vapor deposition methods, such as thermal CVD, MOCVD, and plasma CVD. Other methods for forming the negative electrode layer 4 include liquid-phase deposition methods, such as plating, the sol-gel method, and spin coating. Alternatively, it is possible to lay a metallic layer capable of absorbing and releasing alkali metal ions on a metallic layer containing a metal element neither absorbing nor releasing alkali metal ions by any method described above and then alloy these metallic layers.

When the negative-electrode active material of the negative electrode layer 4 is in a composite form, the negative-electrode active material preferably contains at least one selected from the group consisting of metal powder, alloy powder, glass powder, graphite, hard carbon, a composite oxide, and a metal oxide. Examples of the glass powder include oxide-based glasses and sulfide-based glasses. Examples of the composite oxide include P2-Na_{0.66}[Li_{0.22}Ti_{0.78}]O₂ and Li₄Ti₅O₁₂. Examples of the metal oxide include SnO, Bi₂O₃, and Fe₂O₃. Carbon materials, including graphite and hard carbon, have difficulty in adhering to the solid electrolyte layer 2 and difficulty in forming an ion-conducting path between the solid electrolyte layer 2 and the negative electrode layer 4. Even in such a case, this embodiment enables the adhesion of the solid electrolyte layer 2 and the negative electrode layer 4 through the alkali metal layer 3, so that good battery characteristics can be achieved.

Examples of the binder that can be used include polyacrylic acid and sodium carboxymethyl cellulose (CMC-Na).

An example of the conductive agent that can be used is a conductive carbon. Examples of the conductive carbon include acetylene black and carbon black.

Solid Electrolyte Layer;

In this embodiment, the solid electrolyte layer 2 is made of an alkali metal ion-conducting oxide. Examples of the alkali metal ion-conducting oxide include beta-alumina and NASICON crystals both of which have excellent alkali metal ion-conductivity. These solid oxide electrolytes are less likely to soften and fluidize during thermal treatment and, therefore, have difficulty in adhering to the negative electrode layer 4 and difficulty in forming an ion-conducting path between the solid electrolyte layer 2 and the negative electrode layer 4. Even in such a case, this embodiment enables the adhesion of the solid electrolyte layer 2 and the negative electrode layer 4 through the alkali metal layer 3, so that good battery characteristics can be achieved. Materials described below are those suitable when sodium ions are used as an example of alkali metal ions for use as carrier ions.

Beta-alumina includes two types of crystals: β-alumina (theoretical composition formula: Na₂O.11Al₂O₃) and β″-alumina (theoretical composition formula: Na₂O.5.3Al₂O₃). β″-alumina is a metastable material and is therefore generally used in a state in which Li₂O or MgO is added as a stabilizing agent thereto. β″-alumina has a higher sodium-ion conductivity than β-alumina. Therefore, β″-alumina alone or a mixture of β″-alumina and β-alumina is preferably used and Li₂O-stabilized β″-alumina (Na_{1.7}Li_{0.3}Al_{10.7}O₁₇) or MgO-stabilized β″-alumina ((Al_{10.32}Mg_{0.68}O₁₆) (Na_{1.68}O)) is more preferably used.

Examples of the NASICON crystal include Na₃Zr₂Si₂PO₁₂, Na_{3.2}Zr_{1.3}Si_{2.2}P_{0.7}O_{10.5}, Na₃Zr_{1.6}Ti_{0.4}Si₂PO₁₂, Na₃Hf₂Si₂PO₁₂, Na_{3.4}Zr_{0.9}Hf_{1.4}Al_{0.6}Si_{1.2}P_{1.8}O₁₂, Na₃Zr_{1.7}Nb_{0.24}Si₂PO₁₂, Na_{3.6}Ti_{0.2}Y_{0.7}Si_{2.8}O₉, Na₃Zr_{1.88}Y_{0.12}Si₂PO₁₂, Na_{3.12}Zr_{1.88}Y_{0.12}Si₂PO₁₂, and Na_{3.6}Zr_{0.13}Yb_{1.67}Si_{0.11}P_{2.9}O₁₂, and Na_{3.12}Zr_{1.88}Y_{0.12}Si₂PO₁₂ is particularly preferred because it has excellent sodium-ion conductivity.

The solid electrolyte layer 2 can be produced by mixing raw material powders, forming the mixed raw material powders into a shape, and then firing them. For example, the solid electrolyte layer 2 can be produced by making the raw material powders into a slurry, forming the slurry into a green sheet, and then firing the green sheet. Alternatively, the solid electrolyte layer 2 may be produced by the sol-gel method.

The average particle diameter of the solid electrolyte powder in the form of raw material powders is preferably 0.05 μm to 3 μm both inclusive, more preferably not less than 0.05 μm and less than 1.8 μm, still more preferably 0.05 μm to 1.5 μm both inclusive, and particularly preferably 0.1 μm to 1.2 μm both inclusive. If the average particle diameter of the solid electrolyte powder is too small, not only the solid electrolyte powder becomes difficult to uniformly mix together with the positive-electrode active material precursor powder, but also may absorb moisture or become carbonated to decrease the ionic conductivity or may promote an excessive reaction with the positive-electrode active material precursor powder. As a result, the internal resistance of the positive-electrode material layer increases, so that the voltage characteristics and the charge and discharge capacities tend to decrease. On the other hand, if the average particle diameter of the solid electrolyte powder is too large, this significantly inhibits the softening and flow of the positive-electrode active material precursor powder, so that the resultant positive-electrode material layer tends to have poor smoothness to decrease the mechanical strength and tends to increase the internal resistance.

Positive Electrode Layer;

The material for the positive electrode layer 26 is not particularly limited as long as it contains a positive-electrode active material capable of absorbing and releasing alkali ions and functions as the positive electrode layer 26. Materials described below are those suitable when sodium ions are used as an example of alkali metal ions for use as carrier ions.

Examples of active-material crystals acting as the positive-electrode active material include sodium transition metal phosphate crystals containing Na, M (where M represents at least one transition metal element selected from Cr, Fe, Mn, Co, and Ni), P, and O. Specific examples include Na₂FeP₂O₇, NaFePO₄, Na₃V₂ (PO₄)₃, Na₂NiP₂O₇, Na_{3.64}Ni_{2.18}(P₂O₇)₂, Na₃Ni₃(PO₄)₂(P₂O₇), Na₂CoP₂O₇, and Na_{3.64}Co_{2.18}(P₂O₇)₂. These sodium transition metal phosphate crystals are preferred because they have high capacity and excellent chemical stability. Among them, preferred crystals are triclinic crystals belonging to space group P1 or P−1 and, particularly, crystals represented by a general formula NaₓM_{y}P₂O_{z} (1.20≤x≤2.8, 0.95≤y≤1.6, and 6.5≤z≤8) because these types of crystals have excellent cycle characteristics. Other types of active material crystals acting as the positive-electrode active material include layered sodium transition metal oxide crystals, such as NaCrO₂, Na_{0.7}MnO₂, and NaFe_{0.2}Mn_{0.4}Ni_{0.4}O₂. The positive-electrode active material crystals contained in the positive electrode layer may be in a single phase in which a single type of crystals precipitate, or may be in the form of mixed crystals in which a plurality of types of crystals precipitate.

The positive electrode layer 26 may contain a binder and a conductive agent, both of which are of the same types as those in the negative electrode layer 4.

The positive electrode layer 26 may be formed, for example, by firing active material precursor powder, such as glass powder. By firing the active material precursor powder, active material crystals precipitate and acts as the positive-electrode active material.

Current Collector Layer;

The material for the current collector layer 5 and the current collector layer 27 is not particularly limited, but metallic materials, such as aluminum, titanium, silver, copper, stainless steel or an alloy of any of them, can be used. These metallic materials may be used singly or in combination of two or more of them.

The method for forming the current collector layer 5 and the current collector layer 27 is not particularly limited and examples include physical vapor deposition methods, such as evaporation coating and sputtering, and chemical vapor deposition methods, such as thermal CVD, MOCVD, and plasma CVD. Other methods for forming the current collector layer 5 and the current collector layer 27 include liquid-phase deposition methods, such as plating, the sol-gel method, and spin coating. However, the current collector layer 5 and the current collector layer 27 are preferably formed by sputtering because excellent adhesion is provided.

[Production Method]

(Electricity Storage Device According to Second Embodiment)

Hereinafter, a description will be given of an example of a method for producing an all-solid-state battery 20 serving as an electricity storage device according to the second embodiment. In producing the member 1 for an electricity storage device alone, it is sufficient to omit the step of forming the positive electrode layer 26 and the step of forming the current collector layer 27.

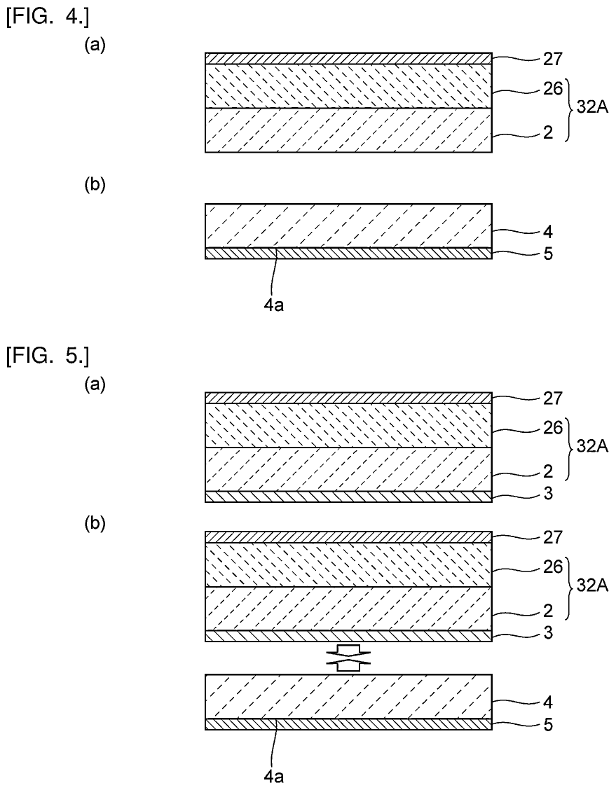

FIGS. 4(a) and 4(b) are frontal cross-sectional views for illustrating an example of a method for producing the electricity storage device according to the second embodiment. FIGS. 5(a) and 5(b) are frontal cross-sectional views for illustrating the example of the method for producing the electricity storage device according to the second embodiment.

First, as shown in FIG. 4(a), a solid electrolyte layer 2 is prepared. Next, a positive electrode layer 26 is formed on the solid electrolyte layer 2. Thus, a positive electrode layer/solid electrolyte layer member 32A is obtained. Next, a current collector layer 27 is formed on the positive electrode layer 26 of the positive electrode layer/solid electrolyte layer member 32A. Meanwhile, as shown in FIG. 4(b), a current collector layer 5 is prepared. Next, a negative electrode layer 4 is formed on the current collector layer 5.

Next, as shown in FIG. 5(a), an alkali metal layer 3 is laid on the solid electrolyte layer 2 of the positive electrode layer/solid electrolyte layer member 32A. Specifically, an alkali metal layer 3 prepared separately is pressure-bonded to the surface of the solid electrolyte layer 2. Since, as described previously, the alkali metal layer 3 has high flexibility, the shape of the alkali metal layer 3 can be suitably conformed to the surface shape of the solid electrolyte layer 2. Thus, an ion-conducting path can be easily formed. The alkali metal layer 3 may be formed on the solid electrolyte layer 2, for example, by sputtering, vacuum vapor deposition or the like. Also in these cases, the shape of the alkali metal layer 3 can be conformed to the surface shape of the solid electrolyte layer 2.

Next, as shown in FIG. 5(b), the alkali metal layer 3 provided on the positive electrode layer/solid electrolyte layer member 32A is pressure-bonded to the negative electrode layer 4. Next, annealing treatment is performed in a state where the positive electrode layer/solid electrolyte layer member 32A, the alkali metal layer 3, and the negative electrode layer 4 are laid one on another. Thus, an alkali metal contained in the alkali metal layer 3 diffuses into the negative electrode layer 4. In the manner thus far described, an all-solid-state battery 20 is obtained.

The method for laying the positive electrode layer/solid electrolyte layer member 32A, the alkali metal layer 3, and the negative electrode layer 4 one on another is not limited to the above method. Other examples of the laying method are described below.

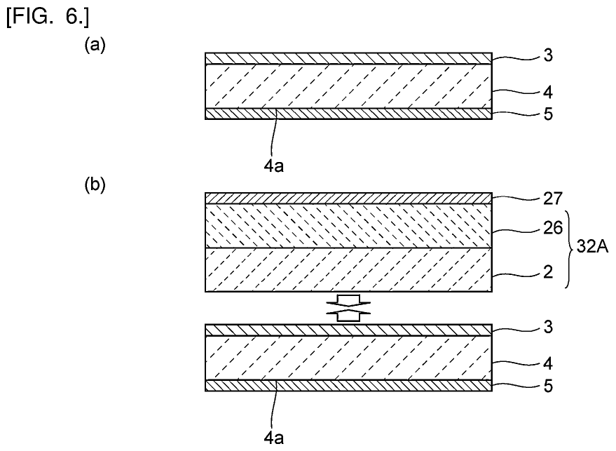

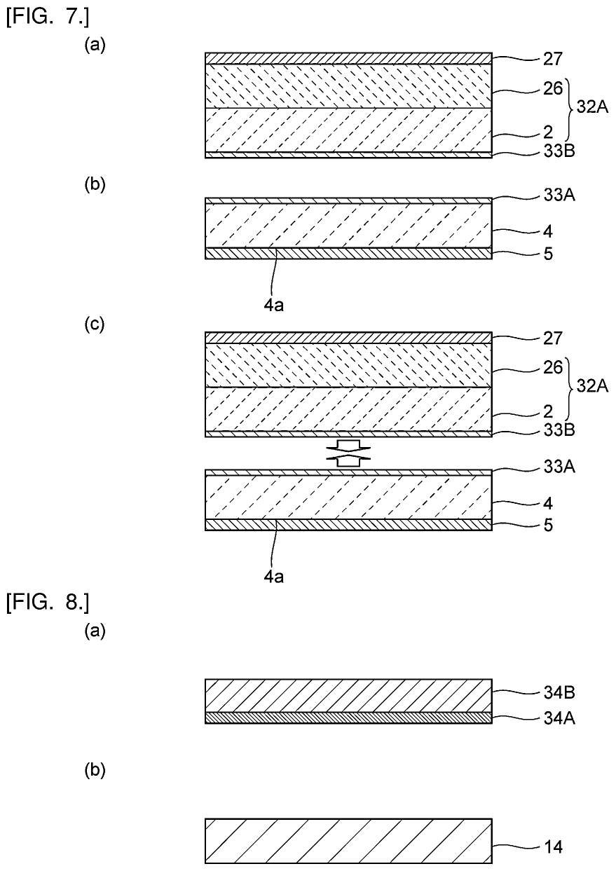

FIGS. 6(a) and 6(b) are frontal cross-sectional views for illustrating another example of a method for producing the electricity storage device according to the second embodiment. FIGS. 7(a) and 7(b) are frontal cross-sectional views for illustrating still another example of a method for producing the electricity storage device according to the second embodiment.

First, as shown in FIG. 6(a), an alkali metal layer 3 is laid on a negative electrode layer 4. Thus, the shape of the alkali metal layer 3 can be suitably conformed to the surface shape of the negative electrode layer 4. Thus, an ion-conducting path can be easily formed. Next, as shown in FIG. 6(b), the alkali metal layer 3 provided on the negative electrode layer 4 is pressure-bonded to a solid electrolyte layer 2 of a positive electrode layer/solid electrolyte layer member 32A. In the manner thus far described, an all-solid-state battery 20 is obtained.

In another example, first, as shown in FIG. 7(a), an alkali metal thin film 33B is laid on a solid electrolyte layer 2 of a positive electrode layer/solid electrolyte layer member 32A. Meanwhile, as shown in FIG. 7(b), an alkali metal thin film 33A is laid on a negative electrode layer 4. The alkali metal thin film 33A and the alkali metal thin film 33B can be formed, for example, by sputtering, vacuum vapor deposition or the like.

Next, as shown in FIG. 7(c), the alkali metal thin film 33A laid on the negative electrode layer 4 and the alkali metal thin film 33B laid on the positive electrode layer/solid electrolyte layer member 32A are pressure-bonded to each other to integrate them, thus forming an alkali metal layer 3. In this case, the shape of the alkali metal layer 3 can be suitably conformed to the surface shapes of both the negative electrode layer 4 and the solid electrolyte layer 2. Hence, an ion-conducting path can be easily enhanced. In the manner thus far described, an all-solid-state battery 20 is obtained.

Hereinafter, a description will be given of an example of a method for producing an all-solid-state battery serving as an electricity storage device including the member 11 for an electricity storage device according to the modification of the first embodiment.

FIGS. 8(a) and 8(b) are frontal cross-sectional views for illustrating an example of a method for producing an electricity storage device using the member for an electricity storage device according to the modification of the first embodiment.

First, as shown in FIG. 8(a), a first metallic layer 34A made of a metal neither absorbing nor releasing alkali metal ions is formed. Next, a second metallic layer 34B made of a metal capable of absorbing and releasing alkali metal ions is laid on the first metallic layer 34A. Next, annealing treatment is subjected to a laminate of the first metallic layer 34A and the second metallic layer 34B to alloy them, thus forming a negative electrode layer 14 as shown in FIG. 8(b).

Meanwhile, a positive electrode layer/solid electrolyte layer member 32A is prepared in the same manner as shown in FIG. 4(a). Next, the positive electrode layer/solid electrolyte layer member 32A, the alkali metal layer 3, and the negative electrode layer 14 are laid one on another in the same manner as shown in FIGS. 5(a) and 5(b), FIGS. 6(a) and 6(b) or FIGS. 7(a) and 7 (b).

Next, annealing treatment is performed in a state where the positive electrode layer/solid electrolyte layer member 32A, the alkali metal layer 3, and the negative electrode layer 14 are laid one on another. Thus, an alkali metal contained in the alkali metal layer 3 diffuses into the negative electrode layer 14. In the manner thus far described, an all-solid-state battery including the member 11 for an electricity storage device is obtained.

### EXAMPLES

Hereinafter, the present invention will be described with reference to examples, but the present invention is not intended to be limited to the examples.

### Example 1

(a) Making of Positive Electrode Layer/Solid Electrolyte Layer Member

2Na₂O—Fe₂O₃-2P₂O₅ glass serving as an active material precursor was made by a melting method. The obtained 2Na₂O—Fe₂O₃-2P₂O₅ glass was coarsely ground in a ball mill and then wet ground in a planetary ball mill, thus making a glass powder having a D50 of 0.6 μm.

β″-alumina (manufactured by Ionotec Ltd.) was coarsely ground in a ball mill and then air classified to make a solid electrolyte powder having a D50 of 1.7 μm.

Acetylene black (“SUPER C65” manufactured by TIMCAL) was used as a conductive agent in a positive electrode layer. The glass powder serving as an active material precursor, the solid electrolyte powder, and the conductive agent were mixed at a weight ratio of 72:25:3, thus obtaining a mixture. Next, relative to 100 parts by mass of the obtained mixture, 10 parts by mass of polypropylene carbonate was added as a binder to the mixture and N-methyl-2-pyrrolidinone was further added as a solvent to the mixture to form a paste.

On the other hand, a β″-alumina plate (manufactured by Ionotec Ltd.) was used as a solid electrolyte layer. The above paste was applied onto the solid electrolyte layer and then dried. The application of the paste was performed so that the amount of supported positive-electrode active material reached 4.5 mg/cm². When the amount of supported positive-electrode active material is 4.5 mg/cm², the capacity per unit area of the formed positive electrode layer is 0.44 mAh/cm². Next, the paste was fired at 500° C. for 30 minutes in a mixed gas of N₂/H₂=96/4 v/v %, thus making a positive electrode layer/solid electrolyte layer member.

Next, a current collector layer made of Al was formed on the surface of the positive electrode layer of the positive electrode layer/solid electrolyte layer member, using a sputtering device. The current collector layer was formed with a thickness of 500 nm.

(b) Making of Negative Electrode Layer

Hard carbon (“BELLFINE LN-0001” manufactured by AT ELECTRODE) was used as a negative-electrode active material. Acetylene black (“SUPER C65” manufactured by TIMCAL) was used as a conductive agent. Sodium carboxymethyl cellulose (manufactured by Daicel FineChem Ltd.) was used as a binder. The negative-electrode active material, the conductive agent, and the binder were mixed at a weight ratio of 80:10:10, thus obtaining a mixture. Next, pure water was added to the obtained mixture, followed by mixing with a planetary centrifugal mixer to form a slurry. Next, the obtained slurry was applied onto a 18 μm thick Al foil. The slurry was applied with a thickness of 300 μm so that the amount of supported negative-electrode active material reached 8 mg/cm². When the amount of supported negative-electrode active material is 8 mg/cm², the capacity per unit area of the formed negative electrode layer is 2.4 mAh/cm². Next, the slurry was dried at 70° C., thus obtaining a dry mixture. Next, the dry mixture in a state disposed on the Al foil was pressed with a pair of rotating rollers, thus obtaining an electrode sheet. Next, the obtained electrode sheet was punched to a circular sheet with a diameter of 11 mm by an electrode cutter. Next, the circular sheet was dried at 140° C. for 6 hours under reduced pressure, thus making a circular negative electrode layer.

(c) Production of All-Solid-State Battery

A metallic sodium foil was obtained by rolling metallic sodium into shape. Next, the obtained metallic sodium foil was punched to a circular shape having a diameter of 11 mm by an electrode cutter. Next, the metallic sodium foil formed into a circular shape was attached to the surface of the negative electrode layer. Thus, a laminate of the metallic sodium foil as an alkali metal layer and the negative electrode layer was obtained. The amount of supported metallic sodium was 10 mg/cm². Next, the metallic sodium layer attached onto the negative electrode layer was pressure-bonded to the surface of the solid electrolyte layer of the above positive electrode layer/solid electrolyte layer member. In the manner thus far described, an all-solid-state battery was obtained.

(d) Production of Test Battery

The all-solid-state battery obtained through the above steps was placed on a lower lid of a coin cell and covered with an upper lid to produce a CR2032-type test battery. The formation of the metallic sodium layer in the step (c) and the step (d) were performed in an argon atmosphere with a dew point of −70° C. or lower.

### Example 2

An all-solid-state battery and a test battery were produced in the same manners as in Example 1 except that in the step (c) a metallic sodium layer was formed by vacuum vapor deposition.

Specifically, a metallic sodium thin film was formed on the surface of a solid electrolyte layer of a positive electrode layer/solid electrolyte layer member by vacuum vapor deposition. The metallic sodium thin film was formed to have a circular shape with a diameter of 11 mm and have an amount of supported metallic sodium of 0.25 mg/cm².

Meanwhile, a metallic sodium thin film was formed, by vacuum vapor deposition, also on a surface of a negative electrode layer formed in the same manner as in Example 1. The metallic sodium thin film was formed to have a circular shape with a diameter of 11 mm and have an amount of supported metallic sodium of 0.25 mg/cm². Thereafter, the metallic sodium thin film formed on the negative electrode layer and the metallic sodium thin film formed on the positive electrode layer/solid electrolyte layer member were pressure-bonded to each other to integrate them, thus forming a metallic sodium layer and obtaining an all-solid-state battery. In Example 2, the amount of supported metallic sodium is 0.5 mg/cm² which is the sum of the respective amounts of supported metallic sodium of both the metallic sodium thin films. Also in Example 2, the formation of the metallic sodium layer was performed in an argon atmosphere with a dew point of −70° C. or lower. Thereafter, a test battery was produced in the same manner as in Example 1.

### Example 3

An all-solid-state battery and a test battery were produced in the same manners as in Example 2 except that the amount of supported metallic sodium was 1 mg/cm² (0.5 mg/cm²+0.5 mg/cm²).

### Example 4

An all-solid-state battery and a test battery were produced in the same manners as in Example 1 except that the amount of supported metallic sodium was 5 mg/cm².

### Example 5

Raw material powders were prepared using stannous pyrophosphate Sn₂P₂O₇ as a main raw material to give 72% by mole SnO and 28% by mole P₂O₅ and also using other various types of oxides, a phosphate raw material, a carbonate raw material, a metallic Sn powder raw material as a reductant, a carbon raw material, and so on. Next, the raw material powders were loaded into a quartz crucible and melted by heating them at 950° C. for 40 minutes in a nitrogen atmosphere using an electric furnace, thus forming a melt. Next, the melt was formed into shape, thus obtaining a film-shaped glass. The obtained glass was coarsely ground in a ball mill and then air classified to make a negative-electrode active material powder having an average particle diameter of 2 μm. When the obtained negative-electrode active material powder was measured by powder X-ray diffraction, it was amorphous and no crystals were detected.

Next, the negative-electrode active material powder, a conductive agent, and a binder were mixed at a weight ratio of 80:5:15, thus obtaining a mixture. The conductive member and binder used was of the same types as in Example 1. Next, pure water was added to the obtained mixture, followed by mixing with a planetary centrifugal mixer to form a slurry. Thereafter, an all-solid-state battery and a test battery were produced in the same manners as in Example 1 except that the amount of supported metallic sodium was 3 mg/cm².

### Example 6

A Cu foil was subjected to electroplating processing in a sulfuric acid bath in which sulfuric acid and an additive for semibright plating were added to stannous sulfate. Semibright plating enables the formation of a film having a lower stress than bright plating. In the sulfuric acid bath, the amount of stannous sulfate was 20 g/L and the amount of sulfuric acid was 150 g/L. In this manner, a Sn layer was formed on the Cu foil, thus obtaining an electrode sheet. In Example 6, the negative-electrode active material is Sn. The thickness of the Cu foil was 20 μm, the thickness of the Sn layer was 7 μm, and the amount of supported Sn was 5 mg/cm². When the amount of supported Sn as a negative-electrode active material is 5 mg/cm², the capacity per unit area of the formed negative electrode layer is 4.5 mAh/cm². Next, the obtained electrode sheet was punched to a circular sheet with a diameter of 11 mm by an electrode cutter. Next, the circular sheet was dried at 120° C. for 6 hours under reduced pressure, thus making a circular negative electrode layer. Thereafter, an all-solid-state battery and a test battery were produced in the same manners as in Example 1 except that the amount of supported metallic sodium was 3 mg/cm².

### Comparative Example

An all-solid-state battery and a test battery were produced in the same manners as in Example 1 except that a negative electrode layer and a positive electrode layer/solid electrolyte layer member both made in the same manners as in Example 1 were directly bonded together with no metallic sodium layer lying in between.

(Charge and Discharge Test)

The produced test batteries of Examples 1 to 6 and the comparative example underwent CC (constant-current) charging from the open circuit voltage to 5 V at 30° C. Next, the test batteries underwent CC discharging from 5 V to 2 V at 30° C. In the charge and discharge test, the C-rate was set at 0.05 C.

The results on the charge/discharge characteristics are shown in Table 1. In the line “Charge/Discharge Result” in Table 1, the test batteries successfully charged and discharged are represented as good and the test battery having failed to be charged and discharged is represented as poor. The term “Discharge Voltage” means an average operating voltage during a first discharge.

TABLE 1

| | | Example | | | | | | |
|---|---|---|---|---|---|---|---|---|
| | | 1 | 2 | 3 | 4 | 5 | 6 | Comp. Ex. |
| Negative | Active material | hard | hard | hard | hard | 72SnO—28P₂O₅ | Sn | hard |
| Electrode | | carbon | carbon | carbon | carbon | glass | | carbon |
| Layer | Amount of Supported | 8 | 8 | 8 | 8 | 8 | 5 | 8 |
| | Active Material | | | | | | | |
| | (mg/cm²) | | | | | | | |
| | Capacity (mAh/cm²) | 2.4 | 2.4 | 2.4 | 2.4 | 2.4 | 4.5 | 2.4 |
| Metallic | Amount of Supported | 10 | 0.5 | 1 | 5 | 3 | 3 | — |
| Sodium | Metallic Sodium | | | | | | | |
| | (mg/cm²) | | | | | | | |
| | Thickness (μm) | 103 | 5 | 10 | 51 | 31 | 31 | — |
| Battery | Charge/Discharge | good | good | good | good | good | good | poor |
| Characteristics | Result | | | | | | | |
| | Discharge Voltage | 2.97 | 2.82 | 2.88 | 2.95 | 2.57 | 2.87 | — |
| | (V) | | | | | | | |

As shown in Table 1, the test batteries of Examples 1 to 6 were successfully charged and discharged at 2.57 V or more. In contrast, the test battery of the comparative example with no metallic sodium layer formed did not operate.

### REFERENCE SIGNS LIST

1 . . . member for an electricity storage device
2 . . . solid electrolyte layer
3 . . . alkali metal layer
4 . . . negative electrode layer
4a . . . outer principal surface
5 . . . current collector layer
11 . . . member for an electricity storage device
14 . . . negative electrode layer
14a . . . outer principal surface
20 . . . all-solid-state battery
26 . . . positive electrode layer
27 . . . current collector layer
32A . . . positive electrode layer/solid electrolyte layer member
33A . . . alkali metal thin film
33B . . . alkali metal thin film
34A . . . first metallic layer
34B . . . second metallic layer

1: A member for an electricity storage device comprising:
a solid electrolyte layer containing an alkali metal ion-conducting solid electrolyte;
an alkali metal layer laid on the solid electrolyte layer and containing an alkali metal; and
an electrode layer laid on the alkali metal layer and containing a material capable of absorbing and releasing alkali metal ions.

2: The member for an electricity storage device according to claim 1, wherein the electrode layer is a negative electrode layer.

3: The member for an electricity storage device according to claim 2, wherein a negative-electrode active material contained in the negative electrode layer is a compound containing at least one selected from the group consisting of metal, alloy, graphite, and hard carbon and an alkali metal element of the same type as contained in the alkali metal layer.

4: The member for an electricity storage device according to claim 3, wherein at least a portion of the negative electrode layer is made of an alloy containing the alkali metal element of the same type as contained in the alkali metal layer.

5: The member for an electricity storage device according to claim 3, wherein the alkali metal contained in the alkali metal layer is diffused into the negative electrode layer.

6: The member for an electricity storage device according to claim 3, wherein the alkali metal element contained in the alkali metal layer is Na and the negative-electrode active material is a compound containing Na.

7: The member for an electricity storage device according to claim 3, wherein the negative-electrode active material contains at least one element selected from the group consisting of Sn, Bi, Sb, and Pb.

8: The member for an electricity storage device according to claim 1, wherein the electrode layer contains a binder.

9: The member for an electricity storage device according to claim 1, wherein the solid electrolyte layer contains an oxide.

10: The member for an electricity storage device according to claim 1, wherein the alkali metal layer has a thickness of not less than 5 nm and not more than 500 μm.

11: An electricity storage device comprising the member for an electricity storage device according to claim 1, wherein
the electrode layer of the member for an electricity storage device is a first electrode layer, and
the electricity storage device further comprises a second electrode layer laid on the solid electrolyte layer to sandwich the solid electrolyte layer together with the alkali metal layer.
